(19) United States
(12) Patent Application Publication
(10) Pub. No.: US 2010/0153896 A1
(43) Pub. Date: Jun. 17, 2010

(54) REAL-TIME CRITICAL PATH MARGIN VIOLATION DETECTOR, A METHOD OF MONITORING A PATH AND AN IC INCORPORATING THE DETECTOR OR METHOD

(75) Inventors: Jeremy Sewall, Yokohama-shi (JP); Kousuke Hazama, Tsukuba (JP); Eric Persson, Tokyo (JP)

Correspondence Address: HITT GAINES, PC;LSI Corporation, PO BOX 832570, RICHARDSON, TX, 75083, US

(73) Assignee: LSI Corporation, Milpitas, CA (US)

(21) Appl. No.: 12/334,441

(22) Filed: Dec. 12, 2008

(51) Int. Cl. G06F 17/50

(52) U.S. Cl. 716/6

(57) ABSTRACT

A margin violation detector for detecting margin violations of critical paths, a method of monitoring data paths and an IC. In one embodiment, the margin violation detector includes: (1) a monitor flip-flop having a monitor input couplable to a critical path input of a capture flip-flop of a critical path, (2) an exclusive OR gate having a first input couplable to an output of the capture flip-flop and a second input couplable to an output of the monitor flip-flop and (3) a violation detect flip-flop having a detection input couplable to an output of the exclusive OR gate.

### TECHNICAL FIELD

This application is directed, in general, to an integrated circuit (IC) and, more specifically, to monitoring data paths of the IC.

### BACKGROUND

Timing critical paths in a device of a digital semiconductor design can be used to determine if the device is performing correctly and is defect free. Typically, the critical paths can be checked by looking for failures at a capturing flip-flop while applying test patterns to sensitize the critical path. This method of checking the critical paths, however, cannot run in real-time while the device is operating in an end application. Additionally, this method of checking the critical paths is directed to indicating when an error has already occurred.

### SUMMARY

One aspect provides a margin violation detector for detecting margin violations of critical paths. In one embodiment, the margin violation detector includes: (1) a monitor flip-flop having a monitor input couplable to a critical path input of a capture flip-flop of a critical path, (2) an exclusive OR gate having a first input couplable to an output of the capture flip-flop and a second input couplable to an output of the monitor flip-flop and (3) a violation detect flip-flop having a detection input couplable to an output of the exclusive OR gate.

Another aspect provides a method of monitoring a data path of an IC. In one embodiment, the method includes: (1) monitoring a critical path employing a capture flip-flop, (2) monitoring the critical path employing a monitor flip-flop that is in addition to the capture flip-flop, (3) comparing a capture output of the capture flip-flop with a monitor output of the monitor flip-flop and (4) providing a margin violation signal when the capture output differs from the monitor output.

Yet another aspect provides an IC. In one embodiment the IC includes: (1) a substrate, (2) a critical path and (3) a margin violation detector for detecting margin violations of the critical path. The margin violation detector includes: (3A) a monitor flip-flop having a monitor input couplable to a critical path input of a capture flip-flop of a critical path, (3B) an exclusive OR gate having a first input couplable to an output of the capture flip-flop and a second input couplable to an output of the monitor flip-flop and (3C) a violation detect flip-flop having a detection input couplable to an output of the exclusive OR gate. The IC also includes (4) a voltage management unit located on the substrate and configured to receive a margin violation detection signal from an output of the violation detect flip-flop and control a voltage of the integrated circuit based thereon.

### BRIEF DESCRIPTION

Reference is now made to the following descriptions taken in conjunction with the accompanying drawings, in which:

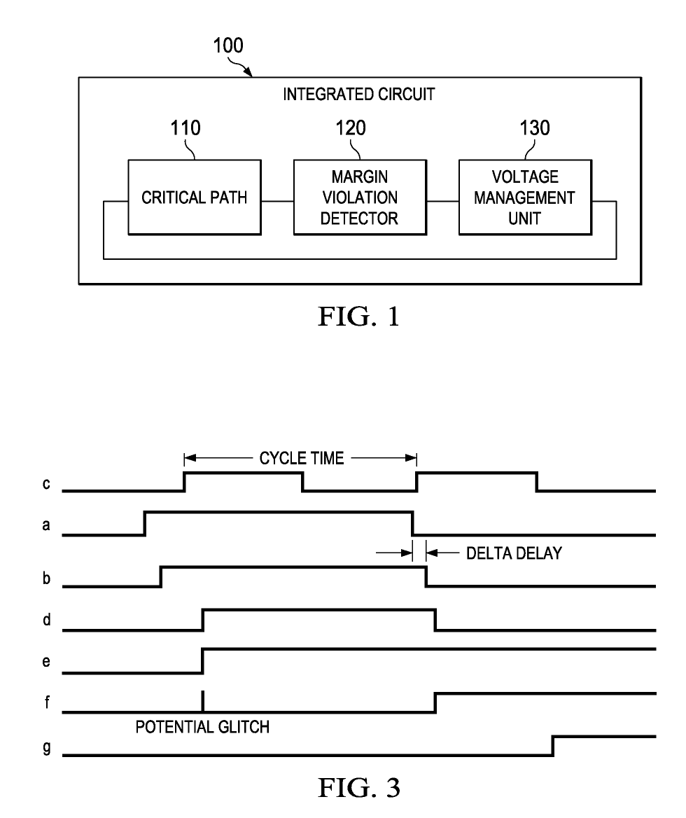

FIG. 1 is a block diagram of an embodiment of an integrated circuit constructed according to the principles of the present invention;

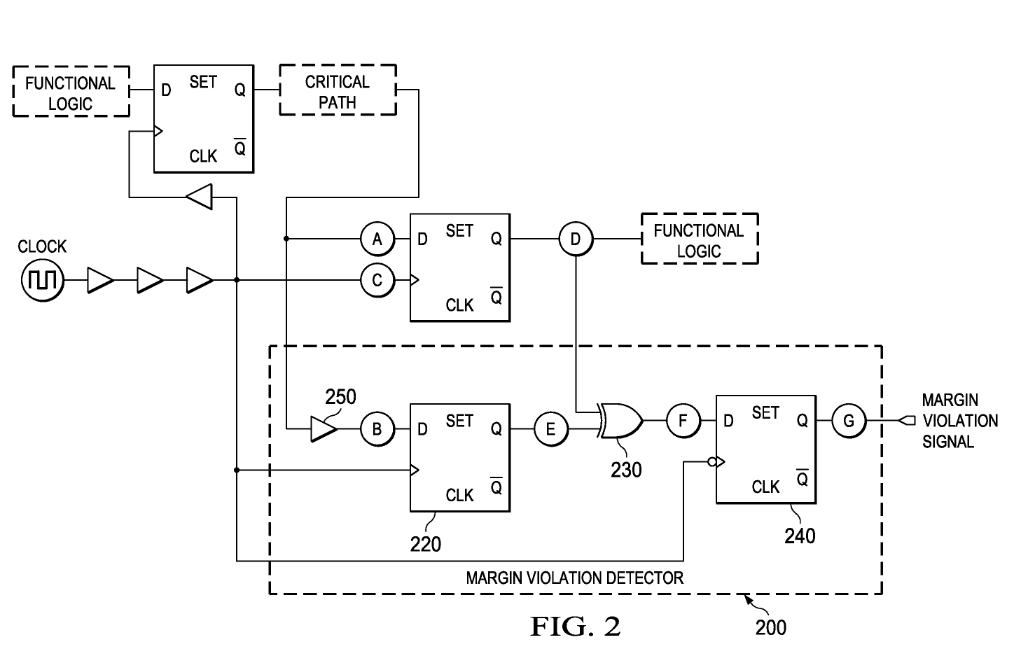

FIG. 2 is a schematic diagram of an embodiment of a margin violation detector constructed according to the principles of the present invention;

FIG. 3 is an example of a timing diagram corresponding to the schematic diagram of the embodiment of a margin violation detector in FIG. 2;

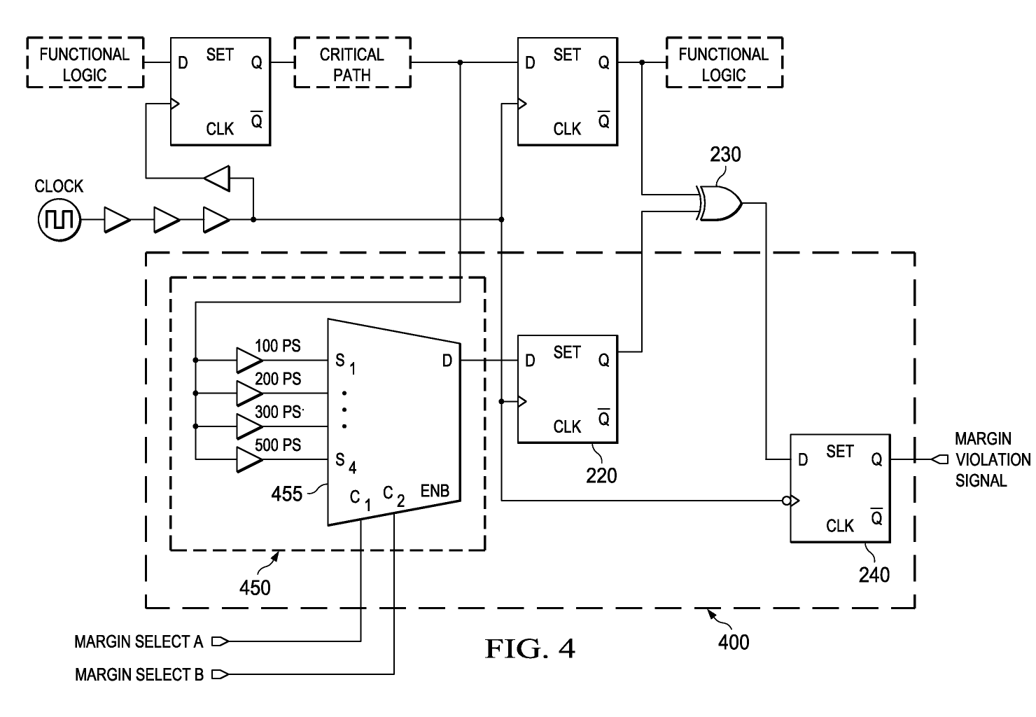

FIG. 4 is a schematic diagram of another embodiment of a margin violation detector constructed according to the principles of the present invention;

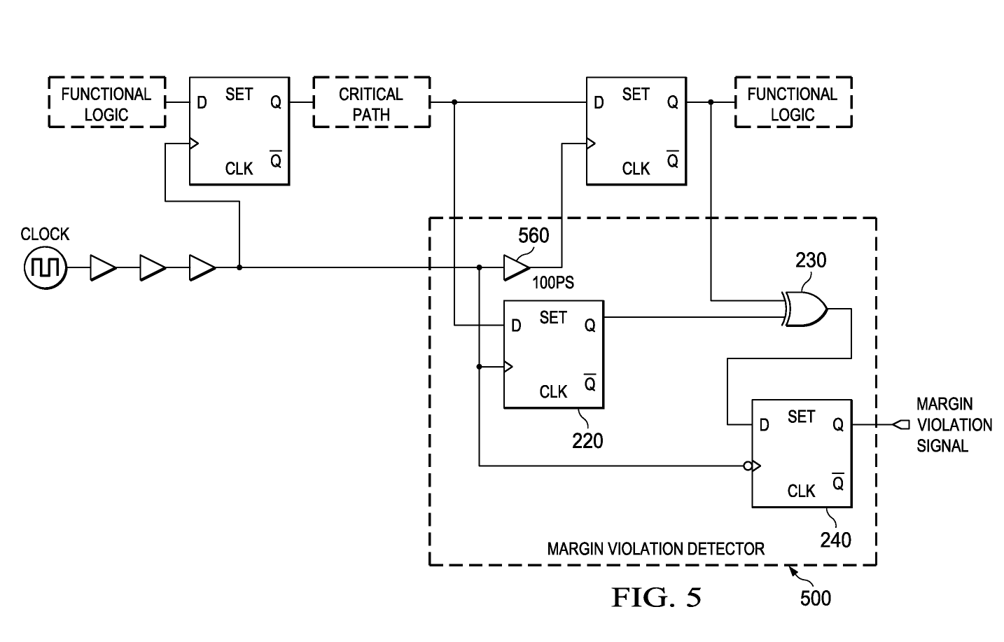

FIG. 5 is a schematic diagram of yet another embodiment of a margin violation detector constructed according to the principles of the present invention;

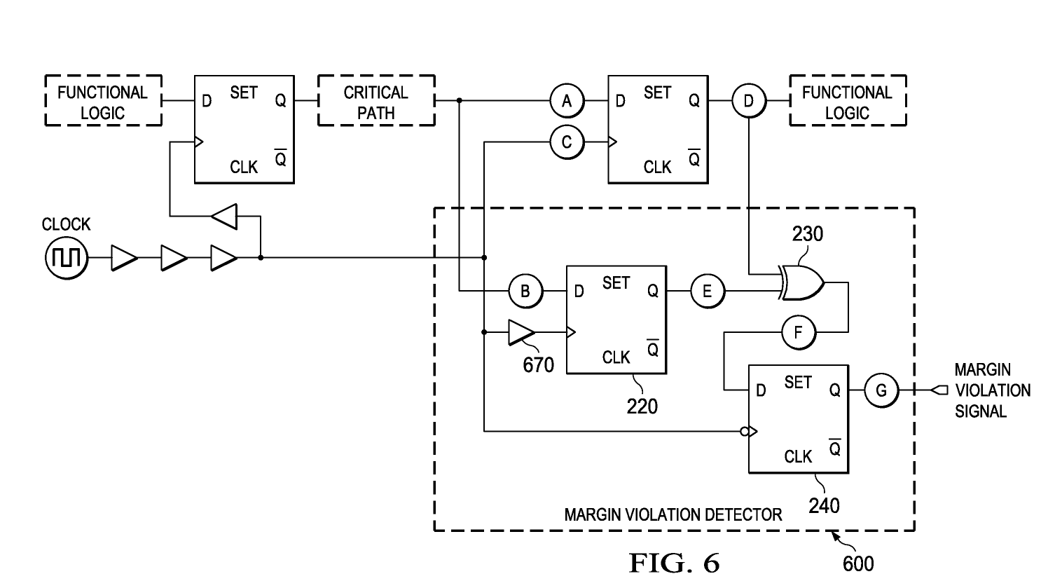

FIG. 6 is a schematic diagram of still another embodiment of a margin violation detector constructed according to the principles of the present invention; and

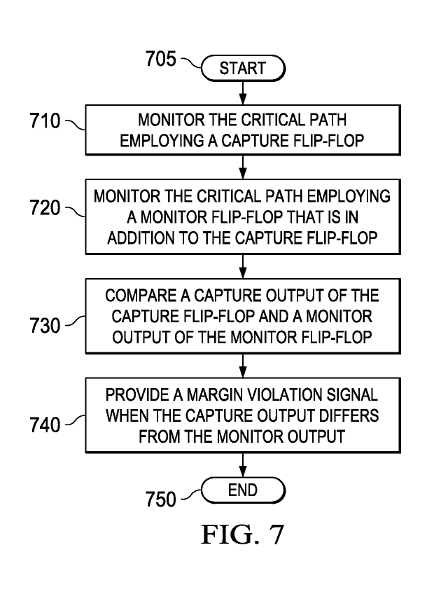

FIG. 7 is a flow diagram of an embodiment of a method of monitoring a data path of an integrated circuit carried out according to the principles of the present invention.

### DETAILED DESCRIPTION

The disclosure recognizes the utility in being able to monitor data paths of ICs before they fail. A circuit, therefore, is disclosed herein to detect that a data path, such as a critical path, is near a failing point (e.g., setup path delay is getting too long, or hold timing path delay is getting too short). The circuit, referred to herein as a margin violation detector, monitors actual functional critical paths during real-time for closed loop real-time monitoring. The margin violation detector can provide the detected information to a voltage management unit to adjust the voltage as needed to prevent a failure. The voltage management unit may provide Adaptive Voltage Scaling (AVS) while the IC is in normal operation and can compensate for temperature variations and device aging as well as process variations. As such, the margin violation detector can be used with AVS applications for closed loop AVS control to reduce the occurrence of failures.

As discussed below, two flip-flops are added to each critical path endpoint in addition to a capturing flip-flop that is typically employed to monitor critical paths. One of the additional flip-flops is a monitor flip-flop and the other additional flip-flop is a violation detect flip-flop.

In some embodiments discussed herein configured to detect a setup margin violation, the D input of the monitor flip-flop is coupled to a delayed version of the D input of the capture flip-flop. The amount of delay of the delay version may be determined by the amount of timing slack available on the critical path and by the amount of margin to detect. The amount of delay can be programmable using a simple multiple delay line scheme with a multiplexer. The select lines of the multiplexer can be tied off using late engineering change orders (ECOs) prior to tapeout (final design stage of the IC wherein the description of a circuit is sent for manufacturing). Alternatively, the amount of delay can be controlled via software or a single delay element.

Also discussed herein is an embodiment of a margin violation detector configured to detect a hold margin violation. In this embodiment, the D input of the monitor flip-flop is coupled to the D input of the capture flip-flop. Additionally, a timing delay is added to the clock path of the monitoring flop.

FIG. 1 is a block diagram of an embodiment of an IC 100 within which a margin violation detector may be constructed or a method of monitoring a data path may be carried out according to the principles of the invention. The IC 100 is formed on or in (those two terms being defined herein as equivalent) a substrate (indicated by an unreferenced box surrounding the IC 100).

The IC 100 also includes a critical path 110, a margin violation detector 120 and a management unit 130. The management unit 130 may be configured for voltage management and/or for frequency management. As such, the management unit 130 will be referred to as a voltage/frequency management unit 130. The IC 100 may include additional logic or components that are not illustrated or discussed herein but are typically included in a conventional IC. For example, the IC 100 may also include a clock supply, functional logic, input and output ports, etc. Additionally, the IC 100 can include multiple critical paths and margin violation detectors to represent multiple clock domains of the IC.

The critical path 110 is used to determine if the IC 100 or at least a clock domain of the IC 100 is performing correctly and is free from defects. The critical path 110 is an actual functional critical path of the IC 100 that may begin at one gate and ends at another gate. For example, the critical path 110 may include a launch flip-flop, combinatorial logic path and a capture flip-flop.

The margin violation detector 120 is configured to detect margin violations of the critical path 110. Thus, instead of waiting to detect failures, the margin violation detector 120 can detect margin violations associated with the critical path 110 before a failure occurs. The voltage/frequency management unit 130 can then adapt the voltage for the clock domain of the IC 100 associated with the critical path 110 to reduce the possibility of a failure occurring.

The margin violation detector 120 may include a monitor flip-flop, an exclusive OR gate and a violation detect flip-flop. To reduce impact on functional path timing, the monitor flip-flop and the capture flip-flop are physically located proximate one another. Having the violation detect flip-flop proximate (and the exclusive OR gate) proximate these two flip-flops also reduces impact on the functional path timing. The monitor flip-flop and the violation detect flip-flop are conventional DQ flip-flops that are clocked. The same clock of the IC 100 can be used to drive the capture flip-flop, the monitor flip-flop and the detect flip-flop. The exclusive OR gate may be unclocked and provide an asynchronous signal to the violation detect flip-flop. These components of the margin violation detector 120 are not illustrated in FIG. 1 but are illustrated in and discussed below in more detail with respect to FIGS. 2 and 4-6. Additionally, the margin violation detector 120 may include additional components in various embodiments discussed herein including a data delay, a setup timing delay or a hold timing delay.

The voltage/frequency management unit 130 is located on the substrate and is configured to receive a margin violation detection signal from an output of the margin violation detector 120. Based thereon, the voltage/frequency management unit 130 is configured to control a supply voltage of the IC 100 to prevent a failure of the actual functional critical path. Accordingly, the voltage/frequency management unit 130 may alter the supply voltage for the clock domain represented by the critical path 110 to prevent a failure from occurring. As with conventional IC management units, the voltage/frequency management unit 130 may also receive an input from the critical path 110 indicating a failure has occurred and alter the supply voltage for the particular clock domain represented by the critical path 110 in response. Additionally, the voltage/frequency management unit 130 may receive an input from the critical path indicating a failure has occurred and alter the frequency for the particular clock domain. In some embodiments, the margin violation detector 120 may be used in an open loop without a voltage/frequency management unit 130. In an open loop application, the margin violation detector 120 may be used for test chips, manufacturing testing, etc.

FIG. 2 is a schematic diagram of an embodiment of a margin violation detector 200 constructed according to the principles of the present invention. The margin violation detector 200 is configured to detect a setup margin violation. The margin violation detector 200 is illustrated in an environment of an IC having functional logic and is shown coupled to a critical path of the IC. A clock of the IC and associated delay elements are also illustrated. Various nodes ‘a’ to ‘g’ are denoted to correspond to the timing diagram of FIG. 3. The margin violation detector 200 includes a monitor flip-flop 220, logic circuitry 230, a violation detector flip-flop 240 and a data delay 250. In the illustrated embodiment, the logic circuitry 230 is an exclusive OR gate 230 and, as such, will referred to hereafter as EX-OR gate 230.

The monitor flip-flop 220 includes a monitor input couplable to a critical path input of the capture flip-flop of the critical path. The critical path input coupled to the monitor input is a delayed version thereof. A delay for the critical path input is provided by the data delay 250.

The EX-OR gate 230 has a first input couplable to an output of the capture flip-flop and a second input couplable to an output of monitor flip-flop 220. The violation detect flip-flop 240 has a detection input couplable to an output of the EX-OR gate 230.

As noted above, the data delay 250 is used to delay the critical path input that is provided to the monitor input of monitor flip-flop 220. As illustrated the data delay 250 is a delay element having a fixed delay. The data delay 250 is selected to provide a delta delay based on a time margin to detect for the critical path. The amount of the delta delay can be changed depending on the amount of margin to check. Data paths having a small amount of available slack may employ a data delay 250 having a smaller delta delay. Accordingly, the value of the delta delay may depend on the available slack (i.e., margin) in the critical path.

Setup slack and hold slack may be defined by the following equations:

setup slack=(cycle_time−data_path_delay−setup_time_required+clock_skew) (Equation 1)

hold slack=data_path_delay−clock_skew−hold_time_required. (Equation 2)

In Equations 1 and 2: (1) clock_skew=((clock delay to capture flop)−(clock delay to launch flop)), (2) setup_time_required=amount of time in advance of arrival of rising clock edge to capture flop, to ensure proper operation of the capture flop and (3) data_path_delay=delay through all elements of the data path, from launch flop to capture flop D input. For simplicity (in an ideal case), the clock skew, setup time required, and hold time required may be ignored since these are typically small factors.

If the critical path delay is shorter than the cycle time generated by the clock and the delta delay from the data delay 250, then the main capture flip-flop and the monitor flip-flop 220 will capture the same value. Hence the exclusive OR of both the outputs of the capture flip-flop and the monitor flip-flop 220 will be zero. Accordingly, the violation detect flip-flop 240 will stay low (i.e., remains at a logical zero) when the next active clock edge arrives from the clock.

If the critical path delay is longer than the cycle time minus the delta delay, but shorter than the cycle time, then the main capture flip-flop will capture the proper value but the monitor flip-flop 220 will capture the incorrect value. Accordingly, the outputs of the capture flip-flop and the monitor flip-flop 220 will differ and the output of the exclusive OR 230 will be one. The output of the exclusive OR 230 will be captured by the violation detect flip-flop 240 at the next active edge of the clock and provided as a margin violation signal. The timing diagram of FIG. 3 illustrates the operation of the margin violation detector 200.

The margin violation signal indicates the critical path timing margin is violated. However, the functional critical path has still behaved correctly. The margin violation signal, therefore, can be provided to a voltage management unit (VMU) of the IC for the VMU to adjust the voltage level as needed before a failure of the critical path occurs.

FIG. 3 is an example of a timing diagram corresponding to the schematic diagram of the margin violation detector in FIG. 2. The clock signal and the cycle time are represented on line ‘c’ of the diagram. The delta delay is indicated on the falling edge of the critical path delay of line ‘a’ and the delay critical path delay of line ‘b.’ Line ‘d’ represents the output of the capture flip-flop and line ‘e’ represents the output of the monitor flip-flop 220. The output of the exclusive OR is represented by line ‘f.’ Line ‘g’ represents the output of the violation detect flip-flop 240, the margin violation signal. When the margin violation signal is high (a logical one), then the critical path is at risk of having a timing violation.

If the arrival time of ‘a’ is too late, then both the capture flip-flop and the monitor flop 220 will capture the “wrong” value. This occurs when there is a real timing violation. In this case, the margin violation signal would not be flagged. Instead, the margin violation signal is only asserted when the critical path is “almost” failing. To also detect when setup timing requirement has been completely violated requires a different monitoring scheme of the critical path than the one disclosed herein. In other words, the disclosed monitoring scheme is used to detect margin violations and may miss explicit timing violations.

FIGS. 4-6 illustrate additional schematic diagrams of embodiments of margin violation detectors constructed according to the principles of the present invention. Each of the margin violation detectors illustrated in FIGS. 4-6 are also in an environment of an IC as in FIG. 1 and include the monitor flip-flop 220, the EX-OR gate 230 and the violation detector flip-flop 240. Margin violation detector 400 illustrated in FIG. 4 also includes a data delay 450. Unlike the data delay 250 which is a fixed delay element, the data delay 450 is configured to provide multiple delta delays that can be selected and applied. The margin violation detector 400, therefore, permits the adjustment of the delta delay and allows for different margin amounts to be monitored. The data delay 450 includes a multiplexer 455 and multiple delay elements coupled to the multiplexer 455 that can be selected by the select lines of the multiplexer 455. The illustrated delay elements are fixed delay elements that provide a 100 ps, a 200 ps, a 300 ps and a 500 ps fixed delay. Of course other delays may be used with the multiplexer 455. With the data delay 450, different delayed versions of the critical path delay can be provided to the monitor flip-flop 220. The select lines can be controlled by software or tied off with late layout ECOs based on a desired timing margin. Late changes ECOs could be applied to the design of the IC to alter the margin select lines based on the amount of timing slack available according to results of testing via, for example, Institute of Electrical and Electronics Engineers (IEEE) 1149.4 compliant System Test Access (STA) devices.

Margin violation detector 500 in FIG. 5 does not include a data delay coupled between the capture flip-flop and the monitor flip-flop 230. Instead, the margin violation detector 500 includes a setup timing delay 560 coupled to the clock input of the capture flip-flop. The setup timing delay 560 is a fixed delay element that is selected based on the timing margin to monitor. Unlike the margin violation detectors 200, 400, the margin violation detector 500 adds a delay to a functional clock path instead of a delta delay to the monitor flip-flop 230 input. Margin violation detector 500 is also configured to detect a setup margin violation.

Margin violation detector 600 of FIG. 6, however, is an embodiment of a detector configured to detect a hold margin violation. The margin violation detector 600 includes a hold timing delay 670 coupled between the clock or clock buffer and the clock input of the monitor flip-flop 230. The hold timing delay 670 is a fixed delay that is selected based on the margin amount associated with a hold violation to monitor. In this embodiment, the margin violation detector 600 indicates a hold margin violation when generating a margin violation signal.

FIG. 7 is a flow diagram of an embodiment of a method of monitoring a data path of an integrated circuit carried out according to the principles of the present invention. The data path may be considered a critical path of an IC. The method 700 begins in a start step 705.

In a step 710, the critical path is monitored employing a capture flip-flop. The capture flip-flop can be the end gate of the critical path. In a step 720, the critical path is monitored employing a monitor flip-flop that is in addition to the capture flip-flop. In one embodiment, the monitor flip-flop monitors the critical path via a data signal on the critical path, the critical path delay that is delayed. In another embodiment, the clock signal to the capture flip-flop is delayed. In still another embodiment, the clock input to the monitor flip-flop is delayed.

A capture output of the capture flip-flop and a monitor output of the monitor flip-flop are then compared in a step 730. An exclusive OR logical gate may be employed for comparing the two outputs. In a step 740, a margin violation signal is provided when the capture output differs from the monitor output. The method 700 then ends in a step 750.

Those skilled in the art to which this application relates will appreciate that other and further additions, deletions, substitutions and modifications may be made to the described embodiments.

What is claimed is:

1. A margin violation detector for detecting margin violations of critical paths, comprising:
a monitor flip-flop having a monitor input couplable to a critical path input of a capture flip-flop of a critical path;
an exclusive OR gate having a first input couplable to an output of said capture flip-flop and a second input couplable to an output of said monitor flip-flop; and
a violation detect flip-flop having a detection input couplable to an output of said exclusive OR gate.

2. The margin violation detector as recited in claim 1 further comprising a data delay coupled between said monitoring input and said critical path input.

3. The margin violation detector as recited in claim 2 wherein said data delay is configured to provide a delay based on a time margin to detect for said critical path.

4. The margin violation detector as recited in claim 3 wherein said data delay is a delay element having a fixed delay.

5. The margin violation detector as recited in claim 3 wherein said data delay includes a multiplexer and multiple delay elements coupled to inputs of said multiplexer.

6. The margin violation detector as recited in claim 1 further comprising a setup timing delay coupled to a clock input of said capture flip-flop.

7. The margin violation detector as recited in claim 1 further comprising a hold timing delay coupled to a clock input of said monitor flip-flop.

8. A method of monitoring a data path of an integrated circuit, comprising:
monitoring a critical path employing a capture flip-flop;
monitoring said critical path employing a monitor flip-flop that is in addition to said capture flip-flop;
comparing a capture output of said capture flip-flop with a monitor output of said monitor flip-flop;
providing a margin violation signal when said capture output differs from said monitor output.

9. The method as recited in claim 8 further comprising employing an exclusive or for said comparing.

10. The method as recited in claim 8 further comprising delaying a data signal of said critical path employing a data delay coupled to a data input of said monitor flip-flop.

11. The method as recited in claim 10 wherein said data delay is configured to provide a delay based on a time margin to detect for said critical path.

12. The method as recited in claim 11 wherein said data delay is a delay element having a fixed delay.

13. The method as recited in claim 11 wherein said data delay includes a multiplexer and multiple delay elements coupled to inputs of said multiplexer.

14. The method as recited in claim 8 further comprising delaying a clock signal employing a setup timing delay coupled to a clock input of said capture flip-flop.

15. The method as recited in claim 8 further comprising delaying a clock input employing a hold timing delay coupled to a clock input of said monitor flip-flop.

16. An integrated circuit, comprising:
a substrate;
a critical path;
a margin violation detector for detecting margin violations of said critical path, including:
a monitor flip-flop having a monitor input couplable to a critical path input of a capture flip-flop of a critical path;
an exclusive OR gate having a first input couplable to an output of said capture flip-flop and a second input couplable to an output of said monitor flip-flop; and
a violation detect flip-flop having a detection input couplable to an output of said exclusive OR gate; and
a voltage management unit located on said substrate and configured to receive a margin violation detection signal from an output of said violation detect flip-flop and control a voltage of said integrated circuit based thereon.

17. The integrated circuit as recited in claim 16 wherein said margin violation detector further comprises a data delay coupled between said monitoring input and said critical path input.

18. The integrated circuit as recited in claim 17 wherein said data delay is configured to provide a delay based on a time margin to detect for said critical path.

19. The integrated circuit as recited in claim 18 wherein said data delay is a delay element having a fixed delay.

20. The integrated circuit as recited in claim 18 wherein said data delay includes a multiplexer and multiple delay elements coupled to inputs of said multiplexer.

21. The integrated circuit as recited in claim 16 wherein said margin violation detector further comprises a setup timing delay coupled to a clock input of said capture flip-flop.

22. The integrated circuit as recited in claim 16 wherein said margin violation detector further comprises a hold timing delay coupled to a clock input of said monitor flip-flop.
